(19) United States
(12) Patent Application Publication
(10) Pub. No.: US 2020/0156073 A1
(43) Pub. Date: May 21, 2020

(54) FUNCTIONALIZED MESH AND FLUIDIC APPARATUS FOR CAPTURING CELLS OR MOLECULES IN SOLUTION

(71) Applicant: Hemosmart Medical Technology Ltd., Kunshan, Jiangsu (CN)

(72) Inventors: Jing Yan, Suzhou, Jiangsu (CN); Jerome Charmet, Coventry (GB); Bauer Wolfgang-Andreas Christian, Suzhou, Jiangsu (CN); Ziyi Yu, Suzhou, Jiangsu (CN); Yang Yang, Suzhou, Jiangsu (CN)

(21) Appl. No.: 16/625,620

(22) PCT Filed: Aug. 2, 2017
(86) PCT No.: PCT/CN2017/095556

§ 371 Date: Dec. 20, 2019

(51) Int. Cl. B01L 3/00

(52) U.S. Cl. CPC B01L 3/502761; B01L 2200/0668; B01L 2300/12; B01L 2200/0652; B01L 2300/0864; B01L 2200/12; B01L 2300/16

(57) ABSTRACT

Disclosed are a functionalized mesh and fluidic apparatus for capturing cells or molecules in solution. The functionalized mesh comprises a mesh substrate and a functional layer formed on said mesh substrate, wherein the functional layer comprises capturing substances that can specifically bind with the target cells or molecules. The mesh and apparatus of the invention have high specificity, as well as high throughput, and are suitable for capturing molecules in solution or expressed at the surface of cell membranes. It is particularly suited to capture and sort circulating tumor cells.

### TECHNICAL FIELD OF THE INVENTION

The present invention relates to apparatus for capturing cells (e.g. circulating tumor cells) via molecules expressed by said cells or molecules in solution, in particular to a functionalized mesh and an apparatus comprising the functionalized mesh for capturing target cells via molecules expressed by said cells or molecules in solution.

### BACKGROUND OF THE INVENTION

Circulating tumor cells (CTCs), which are tumor cells in blood circulation, are considered as having a major relationship with issues such as distant metastasis of tumor. Generally, there is only 1 to 10 CTC(s) in 10 ml blood of cancer patients. Current bottlenecks hindering a rapid detection of cells from blood samples of patients are the low throughput and poor efficiency of capturing devices and methods.

Presently there are several methods for sorting cells, such as the traditional magnetic activated cell sorting method (MACS), membrane microfiltration technology, density gradient centrifugation technology and microfluidic technology etc. The traditional magnetic activated cell sorting method has good reproducibility, high sensitivity and specificity, and is capable of analyzing CTCs quantitatively, however it is unfavorable because of its low operation speed and throughput. The membrane microfiltration and the density gradient centrifugation technologies are simple to operate and enable the capture of cells, however it has low specificity and high false positive rate. There exist different microfluidic enabled CTC sorting/capturing devices. Devices with functionalized posts or devices relying on separation techniques using acoustic, electrophoretic or centrifuge separation and filtration membranes have been used in microfluidic devices. Those devices are simple in operation and require fewer antibodies, but their cost and false negative rate are high and throughput low. Also, presently microfluidic technology companies are mainly focusing on research customers. The method requires mixing a variety of reagents in advance and is over-reliant on fabrication techniques that are not easily transferable to medium to large-scale manufacturing, thus the devices are difficult to industrialize and not easily applicable to in vitro diagnosis.

Also, there is a Cell Search device provided by an US company. This device has advantages of high sensitivity and specificity, but its blood consumption is large, the required amount of antibodies and cost are high, it fails to capture living cells and cannot be used to collect and re-culture CTCs. Consequently, it can be used for DNA sequencing but not for RNA sequencing and medication guidance.

### SUMMARY OF THE INVENTION

One purpose of the present invention is to provide a functionalized mesh for capturing target cells or molecules in solution, comprising a mesh substrate and a functional layer formed on said mesh substrate, wherein said functional layer comprises capturing substances that are specifically bindable with the target cells or molecules. The functionalized mesh of the invention has high specificity, as well as high throughput and is suitable for capturing cells via molecules expressed by said cells or molecules in solution. It is particularly suited to capture and sort circulating tumor cells.

Preferably, said molecules are proteins, oligonucleotides (DNA and/or RNA), enzymes or any combination thereof in solution or expressed by cells.

Preferably, said capturing substances are selected from the group consisting of antibodies (including nanobodies), oligonuecleotides (including aptamer) and molecularly imprinted polymers.

Preferably, said capturing substances are attached to said mesh substrate by physical adsorption and/or chemical bonding.

Further preferably, said chemical bonding is achieved by using thiolated molecules with or without a linker, using traut's reagent, silanisation or click chemistry.

Further preferably, said capturing substances are antibodies, which are attached to said mesh substrate by using traut's reagent or thiolated molecules with biotin-avidin.

Specifically, said antibodies are anti-epithelial cell adhesion molecule antibodies, which can specifically bind with epithelial cell adhesion molecule expressed at the surface of circulating cancer cell.

More specifically, said anti-epithelial cell adhesion molecule antibodies are attached to said mesh substrate by traut's reagent or thiolated molecules with biotin-avidin.

Preferably, said mesh substrate is 2-10 mm×2-10 mm in size and the opening of said mesh is 20 μm-100 μm.

Preferably, the material of said mesh substrate is metal.

Further preferably, the metal is gold, stainless steel or their combination.

Specifically, the mesh substrate comprises:

a stainless steel body; and

a surface coating provided on the surface of said stainless steel body;

wherein said surface coating is made of gold or other noble metal or alloy thereof (such as AuPd), and said capturing substances are attached to said surface coating.

Preferably, said surface coating is deposited using magnetron sputtering or electrochemistry.

Another purpose of the present invention is to provide a fluidic apparatus for capturing cells or molecules in solution, comprising a capturing device, wherein said capturing device comprises at least one functionalized mesh as set forth above. The apparatus of the invention has high specificity, as well as high throughput and is suitable for capturing cells via molecules expressed by said cells or molecules in solution. It is particularly suited to capture and sort circulating tumor cells.

Preferably, said capturing device comprises one or multiple said functionalized mesh(es) stacked together.

Preferably, said apparatus further comprises a body which has an inlet, a first outlet and a cavity located between said inlet and said first outlet, said capturing device is fixed inside said cavity, said inlet and said first outlet communicate with the cavity. Preferably the body is fabricated using established manufacturing technique such as injection moulding. The material of the body should also be compatible with solvents. For example, PEEK (polyetheretherketone) would fulfill both conditions.

Further preferably, said cavity is divided into two parts namely a first cavity and a second cavity by said capturing device. Said mesh is horizontally disposed, said inlet is located above the capturing device and communicated with said first cavity; said first outlet is located below the capturing device and communicated with said second cavity.

Further preferably, the central lines of said inlet and said first outlet are perpendicular to the plane of said functionalized mesh.

Preferably, said body further has a second outlet and a microfluidic channel communicated with said cavity and said second outlet for collection of captured cells or molecules is provided inside of said body.

Preferably, said apparatus further comprises a counting device arranged in said microfluidic channel for counting captured cells or molecules.

Preferably, said counting device comprises electrodes for impedance measurement.

Preferably, said cavity is divided into two parts namely a first cavity and a second cavity by said capturing device, said inlet is communicated with said first cavity, said microfluidic channel is communicated with said second cavity.

Due to the adoption of the above technical solutions, the present invention has the following advantages and effects over the prior art:
easier functionalisation and higher throughput compared to microfluidic device using functionalized surfaces;
low risk of clogging compared to microfluidic device using microfilters;
higher specificity;
potentially higher efficiency compared to other techniques;
apparatus designed so as to be compatible with conventional manufacturing processes (e.g. injection moulding);
compatible with a range of established counting techniques;
possibility to collect the cells after the assay.

### BRIEF DESCRIPTION OF THE DRAWINGS

FIG. 1 is a schematic view of the apparatus for capturing CTCs according to the present invention.

FIG. 2 is a schematic view of the functionalized mesh according to the present invention with captured CTCs.

FIG. 3 is a section view of part of the functionalized mesh according to the present invention.

FIG. 4a is a flow diagram of the method for capturing circulating tumor cells;

FIG. 4b shows a typical workflow of sorting circulating tumor cells by using the apparatus shown in FIG. 1.

FIGS. 5a and 5b are images showing two kinds of circulating tumor cells expressing target capture molecule captured on functionalized mesh.

Wherein: 1—body; 10—cavity; 101—upper cavity; 102—lower cavity; 11—inlet; 12—first outlet; 13—microfluidic channel; 14—second outlet;

2—capturing device; 20—mesh; 201—stainless steel body; 202—surface coating; 21—antibodies;

3—counting device; 30—electrode;

4—circulating cancer cell; 5—blood cell.

### DETAILED DESCRIPTION OF EXEMPLARY EMBODIMENTS

In the following, the present invention is described in detail combining with the accompanying drawings and embodiments.

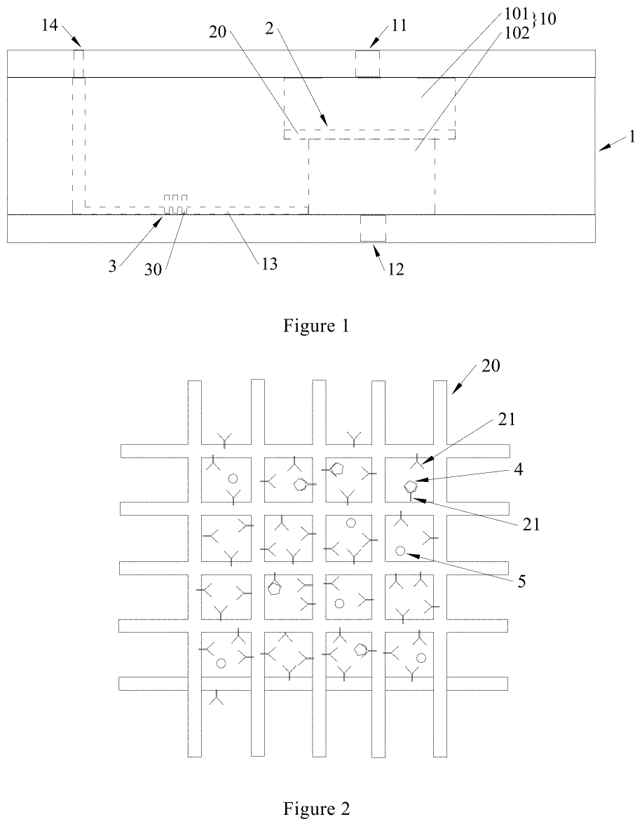

The apparatus disclosed in the present invention relies on using one or more functionalized mesh(s) to capture circulating tumor cells (CTCs) in a hybrid macro/micro-fluidic device (FIG. 1). The “macro” part is used to optimize the capture by increasing the capture area while minimizing the time of the assay. The “micro” part will be used to detect and collect the CTCs.

FIG. 1 shows an exemplary embodiment of a fluidic apparatus for capturing CTCs. The apparatus comprises:

a body 1 with a cavity 10 inside and having an inlet 11 and a first and second outlet 12 and 14;

a capturing device 2 comprising at least one functionalized mesh 20; and

a counting device 3;

Wherein, the body 1 is fabricated using established manufacturing technique such as injection moulding. The material of the body should also be compatible with solvents. For example, PEEK (polyetheretherketone) would fulfill both conditions. Preferably, the body 1 is manufactured by injection moulding to form the cavity 10. The capturing device 2 is arranged in the cavity 10. The inlet 11 and the first outlet 12 are set at two ends of the cavity respectively and communicated with the cavity 10, and the capturing device 2 is located inside the cavity 10 and between the inlet 11 and the first outlet 12. More specifically, the inlet 11 is opened on the top surface of the body 1 and the first outlet 12 is opened on the bottom surface of the body 1, i.e. the inlet 11 is above the capturing device 2 and the first outlet 12 is below the capturing device 2. The cavity 10 is divided into two parts namely the upper cavity 101 (the first cavity) and the lower cavity 102 (the second cavity) by the capturing device 2. Both the upper cavity 101 and the lower cavity 102 are cuboid and the cross section area along horizontal direction of the upper cavity 101 is larger than that of the lower cavity 102. The functionalized mesh 20 of the capturing device 2 is prepared to have capturing substances that can specifically bind with target cells or molecules expressed by cells in solution or expressed at the surface of a cell membrane using any affinity base technique. Target cells or molecules in medium especially solution (e.g. unprocessed blood) can be led into the upper cavity 101 through the inlet 11 and then flow through the capturing device 2 to the lower cavity 102 and finally flow out of the body 1 through the first outlet 12. During this process, target cells or molecules are captured by the capturing device 2 while other part of the blood goes through the capturing device 2 untrapped. The advantage of the functionalized mesh is the high surface to volume ratio allowing the processing of large volume of samples while minimizing the risk of clogging. Once the target cells or molecules have been captured, they can be released (e.g. chemically, thermally, electrically) for further analysis. Typically, the cells are counted and then collected for further analysis. The mesh can captures any target cells or molecules and these molecules can either be “floating” in a solution (biofluid or else) or attached to a cell (in this case, it will be capturing the cells). The capturing device 2 may consists of multiple functionalized meshes stacked together.

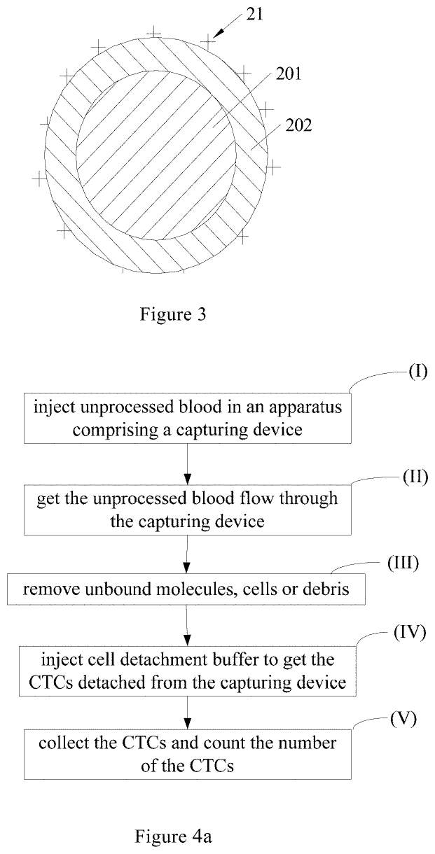

In one embodiment, as shown in FIG. 2, antibodies 21 which can capture molecule on the surface of circulating cancer cell are attached to each mesh 20.

Preferably, the antibodies 21 are anti-epithelial cell adhesion molecule (anti-EpCAM) antibodies. The anti-epithelial cell adhesion molecule antibodies can bind with molecule, specifically, epithelial cell adhesion molecule (EpCAM), of circulating cancer cells, thus circulating cancer cells expressing can be captured. It can be seen from FIG. 2 that circulating cancer cells 4 are bound to the antibodies 21 on the mesh 20 while other blood cells 5 are free from the mesh 20.

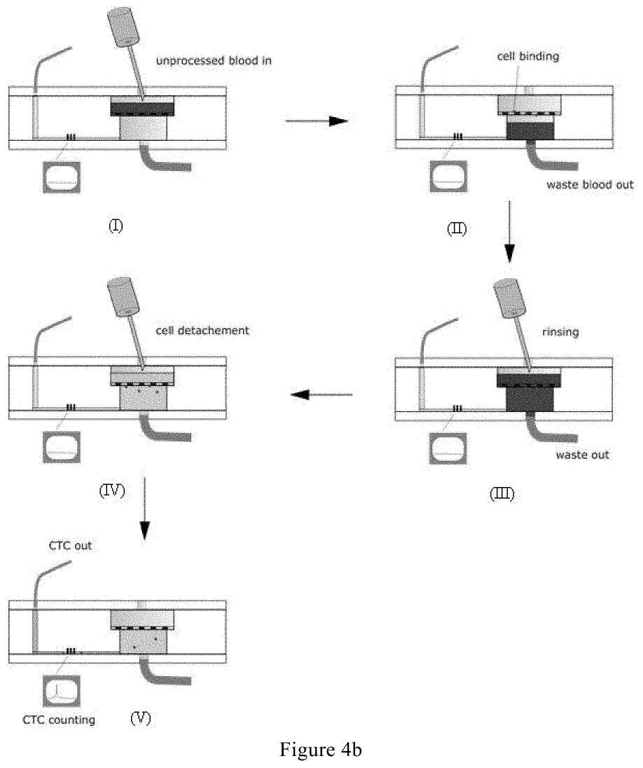

Material of the mesh 20 can be selected from gold or other noble metals and stainless steel coated with gold or other noble metals. Preferably, as shown in FIG. 3, the functionalized mesh 20 comprises: a stainless steel body 201 and a surface coating 202 provided on the stainless steel body 201.

The material of the surface coating 202 is gold or gold alloy (e.g. AuPd), and the antibodies 21 are attached to the surface coating 202. The surface coating 202 is AuPd coating deposited on the stainless steel body 201 by using magnetron sputtering or electrochemistry. The anti-epithelial cell adhesion molecule antibodies are attached to the mesh 20 by traut's reagent, or thiolated biotin-avidin linker instead of traut's reagent.

A microfluidic channel 13 is also provided inside of the body 1, which is communicated with the lower cavity of the cavity 10 through which circulating cancer cells captured by the mesh 20 can be collected, after they are detached from the mesh 20 by cell detachment buffer. The counting device 3 is arranged in the microfluidic channel 13 to count the numbers of captured circulating cancer cells. The counting device 3 comprises electrodes 30 for impedance measurement. The second outlet 14 opened on the top surface of the body 1 is communicated with the microfluidic channel 13 for captured circulating cancer cells flowing out of the body 1.

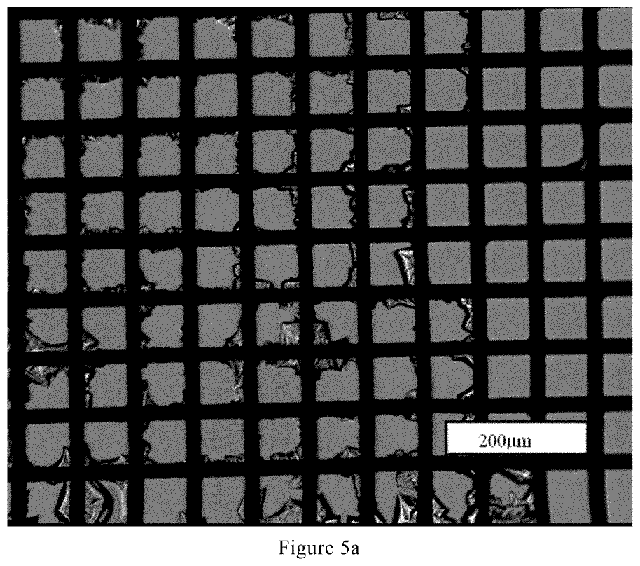

A method for capturing circulating cancer cells, as shown in FIG. 4a, comprises steps of:

(I) injecting unprocessed blood in said apparatus;

(II) getting the unprocessed blood flow though the capturing device so that the CTCs bind to the capturing device;

(III) removing unwanted unbound debris, cells or molecules that may have interacted non-specifically on said capturing device;

(IV) injecting cell detachment buffer to get the CTCs detached from the capturing device; and

(V) collecting the CTCs and counting the number of the CTCs.

As shown in FIG. 4b, specifically, in the step of (I), inject the unprocessed blood in the cavity 10 though the inlet 11 via a pump; in the step of (II), pump down the unprocessed blood through the functionalized mesh 20 so that the CTCs bind to the functionalized mesh 20, reverse the operation of the pump to get the blood pass though the functional; in the step of (III), rinse the functionalized mesh 20 in water or other mild solvent to remove all unbound debris, cells or molecules through the first outlet 12; in the step of (IV), close the first outlet 12 and inject cell detachment buffer (e.g. a buffer containing trypsin) to get the CTCs captured by the mesh 20 detached from the mesh 20; and in the step of (V), collect the CTCs through the microfluidic channel 13 and count the numbers of said CTCs passing though by the electrodes for impedance measurement arranged in the microfluidic channel 13. After counting, said CTCs flow out though the second outlet 14.

Said apparatus is aimed at the requirement of early qualitative and quantitative detection of tumor. The mesh with antibodies is designed by the specific antibody technique. The antibodies are used to screen to ensure a high sensitivity, specificity and cell activity. At the same time, combining the mesh with antibodies and microfluidic technology improves the specific surface area and thus increase the flux. A). as there are significant differences in size of the circulating tumor cells and most of the blood cells, and the circulating tumor cells are easily deformed. An array of at least one said mesh can separate CTCs and retains live cells for subsequent monitoring. B). the anti-EnCAM antibodies are attached to the mesh to ensure a high specificity for cells captured. C). the apparatus containing the mesh is used to increase the flux, reduce the amount of sample, and the single sample operation time will be reduced to ⅓ of the traditional magnetic beads method. Further, the channel of injection can be multipled to further reduce the average operating time.

### Example 1

Herein, a preparation example of the functionalized mesh 20 using for sorting CTCs is given. The preparation method comprises:

(I) choice of the mesh;
gold mesh, the openings (such as, 64 μm or 40 μm) of the gold mesh are chosen so as to maximise the contact time with circulating cells while preventing the risk of clogging. The size of the gold mesh used in the following test was 2×2 mm squares. Larger size is preferred considering manipulation.
Stainless steel and gold mesh, with 51 μm openings were choose and coated with AuPd using magnetron sputtering were also used for that purpose. Such meshes are cheaper and mechanically more stable than their gold counterparts, therefore they are better suited for integration into the proposed apparatus.

(II) pre-functionalization preparation;
A number of cleaning methods were used to prepare the mesh prior to functionalization, including autoclaving, oxygen plasma cleaning, and sonication in various solutions, including piranha solutions. If, for example, the best results for the 64 μm gold mesh consists of 15 minute sonication (US) in detergent, rinsing, 15 minutes sonication (US) in 70% ethanol solution, rinsing, 5 minutes high-purity water. Shorter times can also be expected with harsher solutions (e.g. Piranha).

(III) Antibody;
Typically, 10 μl of antibody was aliquoted out and frozen, and used subsequently to make reaction mixture (i.e. antibody+PBS with EDTA), which is enough for 2×50 μl (50 μl being the minimum volume to immerse a gold mesh of roughly 2 mm square).

(IV) Traut's reagent;
aliquoted and frozen rapidly after purchase. Concentration of traut's reagent was 4:1 ratio compared to the antibody. Other strategies, including thiolated biotin-avidin linker could replace the traut's reagent to attach the antibody to the mesh to form the functionalized mesh.

(V) Incubation time of traut's reagent with antibody;
Optimum reaction time was found to be 1 hour. The time can be shortened in appropriate conditions

(VI) Incubation of above solution with mesh;
various incubation times (ranging from 10 minutes to 12 hours) and different conditions (4° C., room temperature and 37° C.) were tested. The best compromise is 1 hour at room temperature (small improvements were observed for longer incubation times, but were not significant).

### Example 2

Experiments were run to validate the efficiency of the mesh to capture EpCAM expressed by cancer cells. The openings are 51 urn in this case.

Cell choice—cells having high expression level of the EpCAM protein (e.g., CaCo2 and MCF7 cells) were used.

Cell growth—grown at 37 degrees in DMEM buffer.

Preparation of cell and incubation of mesh—the cells were trypsinised and passaged into 1:2 for CaCo2 and MCF7 cells. Tests were also performed on a rotating hot plate at 37° C. After detachment, the cells are diluted 1:10 in DMEM buffer and 0.5 ml was used to incubate the functionalized mesh. Incubation time was 1 hour.

Washing of non-specifically bound cells: the mesh was rinsed using ultra-pure water, incubated in ultra-pure water solution for 2 minutes and rinsed again prior to microscope inspection.

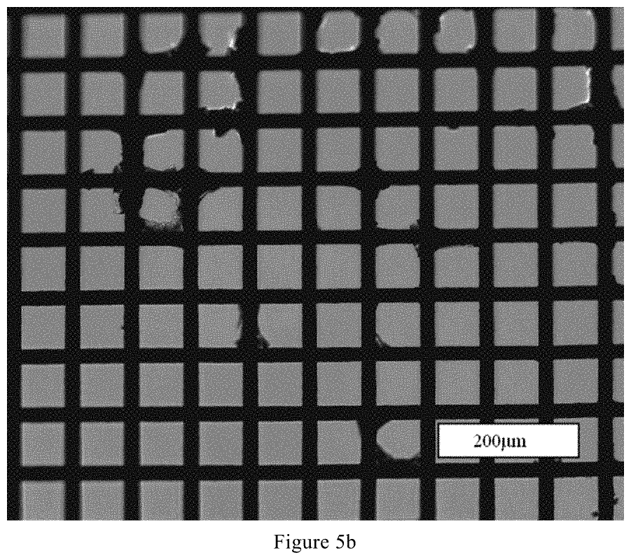

Evaluation of the captured cells using microscopy: Image of the mesh (FIGS. 5a and 5b) are taken by microscopy. FIG. 5a shows CaCo2 cells expressing target capture molecule captured on functionalized mesh after 1 hour incubation, and FIG. 5b shows MCF7 cells expressing target capture molecule captured on functionalized mesh after 1 hour incubation. It can be seen from FIGS. 5a and 5b that a mass of CaCo2 and MCF7 cells were captured by the mesh due to the binding of EpCAM of cells and the anti-EpCAM antibodies on the mesh, while the mesh is not clogged. It should be noted that the apparatus and the method according to the present invention can be used to capture target molecules in solution of various concentration.

The functionalized mesh according to the present invention allows for high contact time with the cells in blood while minimizing the risk of clogging. By using mesh of large surface area, it is possible to process large amounts of sample (ml) in a few minutes. The mesh can be functionalized separately from the rest of the apparatus, thus minimizing the dead volume and therefore the amount of antibodies used for its functionalization and also enabling the use of efficient, but harsh pre-functionalization cleaning steps.

The embodiments described above are only for illustrating the technical concepts and features of the present invention, and intended to make those skilled in the art being able to understand the present invention and thereby implement it, and should not be concluded to limit the protective scope of this invention. Any equivalent variations or modifications according to the spirit of the present invention should be covered by the protective scope of the present invention.

1. A functionalized mesh for capturing cells or molecules in solution, comprising a mesh substrate and a functional layer formed on said mesh substrate, wherein said functional layer comprises capturing substances that are specifically bindable with said cells or molecules.

2. The functionalized mesh according to claim 1, wherein said molecules are proteins, oligonucleotides, enzymes or any combination thereof in solution or expressed by cells.

3. The functionalized mesh according to claim 1, wherein said capturing substances are selected from the group consisting of antibodies, oligonucleotides and molecularly imprinted polymers.

4. The functionalized mesh according to claim 1, wherein said capturing substances are attached to said mesh substrate by physical adsorption and/or chemical bonding.

5. The functionalized mesh according to claim 4, wherein said chemical bonding is achieved by using thiolated molecules with or without a linker, using traut's reagent, silanisation or click chemistry.

6. The functionalized mesh according to claim 4, wherein said capturing substances are antibodies, which are attached to said mesh substrate by using traut's reagent or thiolated molecules with biotin-avidin.

7. The functionalized mesh according to claim 6, wherein said antibodies are anti-epithelial cell adhesion molecule antibodies, which can specifically bind with epithelial cell adhesion molecule expressed at the surface of circulating cancer cell.

8. The functionalized mesh according to claim 7, wherein said anti-epithelial cell adhesion molecule antibodies are attached to said mesh substrate by traut's reagent or thiolated molecules with biotin-avidin.

9. The functionalized mesh according to claim 1, wherein said mesh substrate is 2-10 mm×2-10 mm in size and the opening of said mesh is 20 μm-100 μm.

10. The functionalized mesh according to claim 1, wherein the material of said mesh substrate is metal.

11. The functionalized mesh according to claim 10, wherein the metal is noble metal, stainless steel or their combination.

12. The functionalized mesh according to claim 1, wherein the mesh substrate comprises:
a stainless steel body; and
a surface coating provided on the surface of said stainless steel body;
wherein said surface coating is made of noble metal or alloy thereof, and said capturing substances are attached to said surface coating.

13. (canceled)

14. A fluidic apparatus for capturing cells or molecules in solution, comprising a capturing device, wherein said capturing device comprises at least one functionalized mesh as set forth in claim 1.

15. (canceled)

16. The apparatus according to claim 14, wherein said apparatus further comprises a body which has an inlet, a first outlet and a cavity located between said inlet and said first outlet, said capturing device is fixed inside said cavity, said inlet and said first outlet communicate with the cavity.

17. The apparatus according to claim 16, wherein said cavity is divided into two parts namely a first cavity and a second cavity by said capturing device,
wherein said mesh is horizontally disposed, said inlet is located above the capturing device and communicated with said first cavity, said first outlet is located below the capturing device and communicated with said second cavity.

18. (canceled)

19. The apparatus according to claim 16, wherein the central lines of said inlet and said first outlet are perpendicular to the plane of said functionalized mesh.

20. The apparatus according to claim 16, wherein said body is fabricated using injection moulding.

21. (canceled)

22. The apparatus according to claim 14, wherein said body further has a second outlet and a microfluidic channel communicated with said cavity and said second outlet for collection of captured cells or molecules is provided inside of said body.

23. The apparatus according to claim 22, wherein said apparatus further comprises a counting device arranged in said microfluidic channel for counting captured cells or molecules.

24. (canceled)

25. The apparatus according to claim 22, wherein said cavity is divided into two parts namely a first cavity and a second cavity by said capturing device, said inlet is communicated with said first cavity, said microfluidic channel is communicated with said second cavity.
